(19) United States
(12) Patent Application Publication
(10) Pub. No.: US 2026/0318018 A1
(43) Pub. Date: Oct. 15, 2026

(54) MODULAR SYSTEM OF LASER BARRIERS FOR CONSTRUCTION SITES

(71) Applicant: ISTITUTO NAZIONALE PER L’ASSICURAZIONE CONTRO GLI INFORTUNI SUL LAVORO (INAIL), Roma (RM) (IT)

(72) Inventors: Antonella PIREDDU, Roma (RM) (IT); Raffaele PALOMBA, Roma (RM) (IT)

(21) Appl. No.: 19/485,461

(22) PCT Filed: Jun. 5, 2024
(86) PCT No.: PCT/IB2024/055496

§ 371 Date: Nov. 18, 2025

(30) Foreign Application Priority Data
Jun. 16, 2023 (IT) 102023000012441

(51) Int. Cl. E01F 9/30; E01F 9/627; E01F 9/646; E01F 9/654; G08G 1/005; G08G 1/01

(52) U.S. Cl. CPC E01F 9/30; E01F 9/627; E01F 9/646; E01F 9/654; G08G 1/005; G08G 1/0116

(57) ABSTRACT

According to the present invention, a system of immaterial laser barriers is created which is capable of:-delimiting “construction site-road interface” areas near pedestrians, mechanical means, or vehicles in transit;-generating an acoustic signal for pedestrians and an optical signal for vehicles at each crossing of the barrier. A laser barrier consists of at least two transceivers arranged along the construction site-road interface, mounted on a stable physical support. A microprocessor inside each transceiver detects the crossing of the barrier and activates an acoustic signal, which prescribes the return of workers to the safe area, and an optical signal (such as a traffic light), which prescribes the stopping of vehicles in transit toward the construction site. The immaterial laser barriers are modular, combinable, easily transportable and adapt to the shape of the construction site with minimal encumbrance.

### FIELD OF THE ART

The invention relates to the field of construction site safety. Even more specifically, the invention provides a modular system for the creation of laser barriers able to perform a surveillance of the perimeter of a construction site area.

### PRIOR ART

Passing into and from dangerous work areas can be a cause of serious injury. The collision of workers working on road, construction or quarry sites by vehicles or moving means is frequent, and in many cases associated with serious injuries.

Environments such as short-term road construction sites, but also construction sites and ornamental stone quarries, often operate in limited spaces where workers, pedestrians, vehicles, heavy vehicles, self-propelled work equipment, etc. interact simultaneously. In many cases of confirmed accidents, a worker not involved in the work was hit and crushed by a moving vehicle or machine operating in the same area. The need to delimit and signal certain areas to avoid the impact or crushing of workers by vehicles or moving means is concrete in the environments mentioned.

In the context of monitoring entrances to construction site areas, numerous patents have provided solutions to problems of various kinds.

One example is the object of patent application GB2471784A of P.J. BUNTING. The invention provides a quick installation safety system for use on a construction site, compound or yard. The system comprises a monitoring station, and at least a transportable safety tower located on site. The tower comprises: a video camera mounted on an extendable pole; a safety sensor for generating and transmitting a safety alert in response to the detection of a safety event; and a speaker to emit an acoustic signal in response to a safety alert. At least a safety device is arranged to activate a safety action as a result of a detection. The safety sensor can comprise a smoke detector, fire detector, gas detector, water detector. The safety device can comprise an acoustic alarm, a barrier access actuator or a sprinkler activation device. The system also uses RFID sensors and license plate readers to locate vehicles in transit in the construction site area.

Another example is the object of patent application US2020388152A1 of FH. BRADLEY. The invention relates to a vehicle proximity warning system comprising a plurality of field transmitters, a notification unit and a containing unit. Each field transmitter is positioned outside the vehicle and transmits an encoded signal comprising identification information to determine a corresponding imminent road hazard or road warning. The notification unit includes an antenna for receiving the encoded signal, a receiver for decoding the encoded signal and determining the corresponding impending traffic hazard or traffic warning associated with the encoded signal, an internal transmitter for transmitting an encoded signal requesting assistance for the vehicle and a vehicle interface unit for communicating the corresponding road hazard or road warning to the vehicle operator. The containing unit encloses the notification unit. The containing unit comprises a solar panel for providing power to the notification unit and one or more openings for mounting the containing unit on a fixed structure.

The inventions reported so far, by way of non-exhaustive example, are representative of the inventive-technological framework available to date.

Immaterial barriers can be considered an evolution of the “complementary-type temporary signals” used on road construction sites (Italian Ministerial Decree of Jul. 10, 2002) such as delimitation posts, modular delineators, cones, and flexible delineators. Temporary signals such as warning cones are currently used to delimit and highlight short-term work zones, temporary diversions, and channeling, areas affected by accidents or for the temporary separation of opposite traffic directions. Sometimes synchronous lights are placed on the cones or delineators to highlight deviations in the traffic flow. In the state of the art, there are no devices available for road construction sites capable of delimiting risk areas, detecting the crossing of the interface between areas, alerting both road users (vehicles/pedestrians) and workers regarding the risk of being hit. Fixed protection barriers (e.g., Jersey) offer protection against impact but do not prevent impact. On the contrary, immaterial barriers (laser, or other wireless communication technology) do not protect against impact but prevent it, detecting the crossing of the barrier and signaling the risk of being hit. Other inventions not mentioned but still part of the state of the art propose the use of immaterial barriers in work machines and equipment, where they carry out safety functions to protect access to a dangerous area. For example, when the wireless technology detects a vehicle crossing a barrier, the control circuitry of the barrier sends a stop signal to the car. These systems necessarily require mounting sensors, RFID tags (as for the inventions mentioned) or other types of detectors on vehicles so as to be able to recognize them, and thus do not allow determining and alerting the presence of vehicles to people outside the works.

Further uses of immaterial barriers relate to the detection of intrusions by strangers into private or prohibited areas or also to detect, in areas with limited access, the presence of authorized workers equipped with personal protective equipment or clothing integrated with sensors. Such solutions, although valid, can have limitations related to the protection of the worker's privacy.

The object of the present invention is to provide a system capable of overcoming the aforementioned technical problems and which provides workers with effective methods for preventing accidents at work and which is easily mountable and modular, thus flexibly adapting to any type of road, building, and/or quarry construction site.

The advantages offered by the present invention will be clearer in light of the detailed descriptions which follow.

### DESCRIPTION OF THE INVENTION

According to the present invention, a system of immaterial laser barriers is created which is capable of:
delimiting “construction site-road interface” areas near pedestrians, mechanical means, or vehicles in transit;
generating an acoustic signal for pedestrians and an optical signal for vehicles at each
crossing of the barrier.

Immaterial laser barriers or laser barriers are intended herein as non-visible barriers consisting of a laser beam exchanged by two or more transceivers and specifically exchanged between a laser transmitter and a laser receiver. A laser barrier consists of at least two transceivers arranged along the construction site-road interface, mounted on a stable physical support such as complementary temporary signals (which are signaling posts, road cones and other temporary signaling elements for road works). A microprocessor inside each transceiver detects the crossing of the barrier and activates an acoustic signal, which prescribes the return of workers to the safe area, and an optical signal (such as a traffic light), which prescribes the stopping of vehicles in transit toward the construction site. The immaterial laser barriers are modular, combinable, easily transportable and adapt to the shape of the construction site with minimal encumbrance; they represent a low-cost and immediate solution for all road construction sites and in particular for short-term construction sites.

More specifically, the system of the present invention comprises:
two or more transceivers able to exchange a laser signal through a laser transmitter and a laser receiver. Each transceiver comprises at least a laser transmitter and at least a laser receiver mounted through articulated anchors to a base which provides support to the elements (i.e., the laser transmitter and receiver). Said articulated anchors allow the orientation of the laser transmitter and receiver in the three dimensions of space. A rechargeable battery power supply comprised in the base energetically powers the laser transmitter and receiver. The base then has an interlocking anchor to be able to interlock on top of a complementary temporary signal, such as a traffic cone. Each transceiver comprises said microprocessor which detects interruptions in a laser signal transmitted by the laser transmitter of a first transceiver and received by the laser receiver of a second transceiver, and sends a signal (using a wireless communication technology such as Bluetooth or Wi-Fi) to a control unit. Each transceiver then comprises switches able to activate and deactivate the laser signal between two transceivers, an acoustic signaler able to send an acoustic signal when said microprocessor detects an interruption of a laser signal, a plurality of indicator lights able to send an optical signal when said microprocessor detects an interruption of a laser signal, when two near transceivers are misaligned, when two near transceivers (110) are aligned, when said transceiver is turned on and running;
a control unit able to acquire the signals of the microprocessors of said transceivers and to activate acoustic signaling devices and/or signalers when an interruption of a laser signal between two transceivers is detected by a microprocessor. Said optical signalers able to have a wireless communication unit which receives data from said control unit to send or not a light signal.

According to the present invention, said acoustic signaler, said indicator lights, said acoustic signaling devices, said optical signalers are able to signal to workers when a person and/or a means and/or a vehicle passes between two transceivers, interrupting the laser signal, and signaling to vehicles in transit near said construction site, the possibility that one or more workers are present outside a perimeter outlined by said transceivers.

To set up the barrier, the following steps are followed:
define the area of the construction site to be delimited and all its sides, position the individual complementary temporary signals taking into account a maximum distance of 7.5 m (the preferable distance between two consecutive transceivers is comprised between 2 and 6 m);
mount the transceiver on the complementary temporary signal
   position the first transceiver on the first temporary complementary signal, inserting it by means of said interlocking anchor;
   repeat the previous operation for the second transceiver;
   approximately align the transmitter of the first complementary temporary signal with the receiver of the second complementary temporary signal;
turn on all the transceivers to activate the barrier through the respective switches;
activate the first laser transmitter by pressing a first switch only once, align the beam exiting from the first laser transmitter, aiming at the target of a second laser receiver, activate the second laser receiver by pressing a second switch only once. An indicator light remains fixed if the alignment is correct, if said indicator light is flashing, it indicates the need to improve said alignment by rotating said first laser transmitter and/or said second laser receiver;
activate the acoustic signals by pressing a third switch on each transceiver;
position the control unit on a temporary complementary signal or on another stable support and activate it by means of the switch;
activate said optical signalers (such as traffic lights) by pressing the relative switches.

The advantages offered by the present invention are evident in the light of the description presented thus far and will be even clearer thanks to the attached figures and the related detailed description.

### DESCRIPTION OF THE FIGURES

The invention will be described hereinafter in at least a preferred embodiment by way of non-limiting example with the aid of the appended figures, in which:

FIG. 1 shows a general view of the system 100 according to the present invention;

FIG. 2 shows a view of a transceiver 110 mounted on a complementary temporary signal 10, and a detail view of the transceiver 110 of the system 100 and some of its internal components according to the present invention;

FIG. 3 shows a detailed view of the control unit 130 provided with display 135 for monitoring the barriers and environmental parameters.

### DETAILED DESCRIPTION OF THE INVENTION

The invention describes a system 100 of laser barriers for a construction site 1 with workers 2 delimited by complementary temporary signals 10, which uses acoustic signaling devices 140 such as, by way of example, “sirens,” sound transducers and the like, and optical signalers 150 such as flashing lights, LEDs, traffic lights. In the present invention, “laser barriers” or “immaterial barriers” are intended as non-visible barriers consisting of a laser signal exchanged by two or more transceivers 110 of the system 100. Complementary temporary signals 10 are intended as those temporary signaling elements used to indicate the perimeter of a construction site, such as warning posts, barriers, road cones and the like.

Immaterial barriers are elements which are easy to acquire and assemble. They can be set up in very short times (simply the time taken to position a transceiver 110 and turn it on, on a complementary temporary signal 10 such as a traffic cone), thus representing an optimal solution for short-term construction sites 1. The proposed system 100 occupies a small volume both within construction site 1 and on the road. The barrier is easily modular and transportable together with the other construction site equipment, and lastly it is easily managed by all the workers present. The characteristics and innovative elements of the system 100 derive from the ability to:
delimit risk areas;
Detect the crossing of the interface between areas;
Alert both vehicles or passers-by and workers 2.

The most inventive aspects of the system 100 are represented by the high flexibility of the individual modular elements and their adaptability to the work areas to be delimited and alarmed.

The immaterial barrier is simple to set up and intuitive; with respect to physical barriers, which offer protection in the event of an impact, they are potentially capable of preventing vehicle-human impacts. The system 100 exploits acoustic alarms sent by said acoustic signaling devices 140 and by acoustic signals 119 contained within each transceiver 110. Said acoustic alarms inform workers 2 of a potential danger of being hit by a vehicle and prescribe they return to the safe area. The immaterial barrier is provided with a control unit 130 capable of activating said optical signals 150 such as a double red stop light for approaching vehicles, and said acoustic signaling devices 140 such as a siren with an intense acoustic signal for workers 2. Consequently, a vehicle moving towards the construction site 1 can stop and the worker 2 exposed to collision can return to the safe area. The system 100 thus described is low-cost, easily transportable and adaptable to the shape and size of the construction site 1 and allows a considerable saving of time. It is suitable for use in all outdoor work environments and in particular on short-term construction sites 1. Furthermore, it does not involve a violation of privacy, as no data on the worker is recorded and collected 2.

The advantages just described will be even more apparent in light of the descriptions which follow.

The present invention will now be illustrated by way of a purely non-limiting or binding example, resorting to the figures which illustrate some embodiments with respect to the present inventive concept.

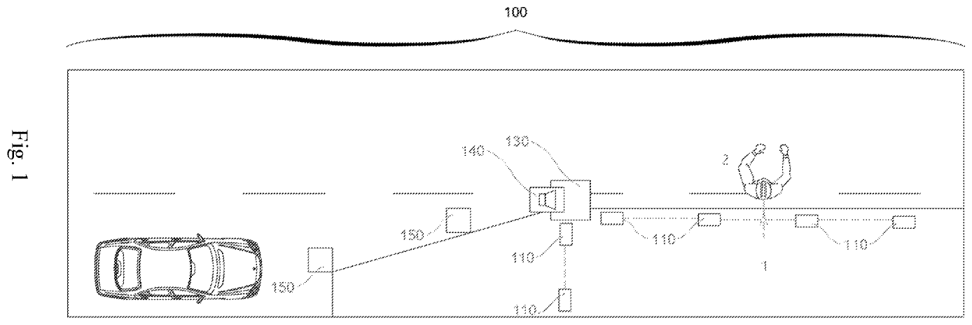

With reference to FIG. 1, a general view is shown of said system 100 according to the present invention. In FIG. 1 as in the following description, the embodiment of the present invention currently considered the best is illustrated.

System 100 of laser barriers for a construction site 1 with workers 2 delimited by complementary temporary signals 10, which uses acoustic signaling devices 140 and optical signalers 150 comprises:
two or more transceivers 110 able to exchange a laser signal;
at least a control unit 130 able to acquire signals of an interrupted laser signal from said transceivers 110.

In FIG. 1, it can be seen how a vehicle arriving from the left side is stopped by said optical signalers 150 (which in FIG. 1 are two traffic lights) which show a red light because said worker 2 has passed between two transceivers 110, interrupting the laser signal thereof. The interruption of the laser signal was followed by a communication to said control unit 130 which activated the red lights in said optical signalers 150 and activated an acoustic signaling device 140 (which in FIG. 1 is a siren) which sends an acoustic signal to the worker 2 so that he returns to the construction site area 1.

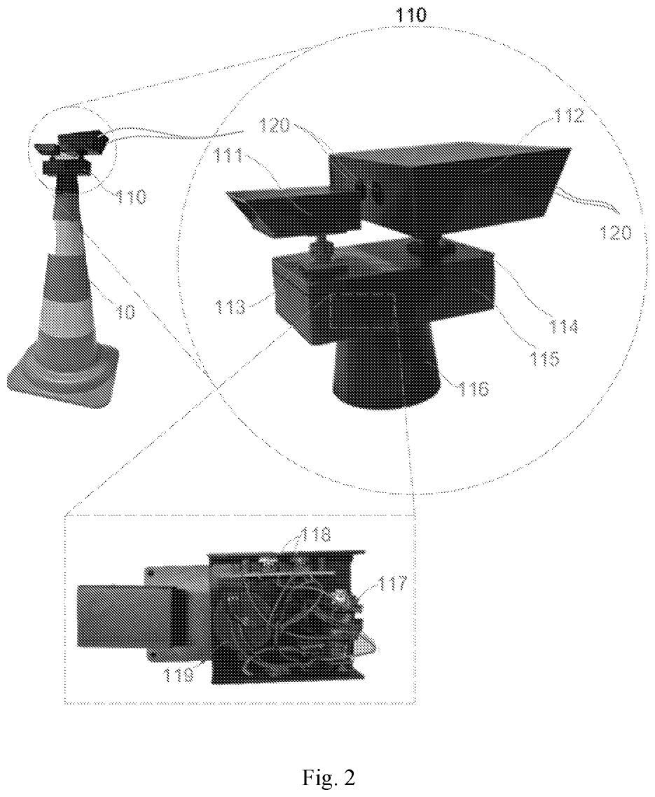

With reference to FIG. 2, a view is shown of said transceiver 110 mounted on a complementary temporary signal 10, and a detail view of the transceiver 110 of the system 100 according to the present invention. The following description will refer to FIGS. 1 and 2.

Said transceiver 110 sends a laser signal through a laser transmitter 111 and a laser receiver 112. Said transceiver 110 comprises at least a laser transmitter 111 and at least a laser receiver 112. Said laser transmitter 111 and laser receiver 112 are mounted through articulated anchors 113 to a base 114 which provides them support. Said articulated anchors 113 allow the orientation of said laser transmitter 111 and laser receiver 112 in the three dimensions of space. Said laser transmitter 111 and laser receiver 112 are energetically powered by a rechargeable battery power supply 115 included in said base 114. Said base 114 has an interlocking anchor 116 to be able to interlock on top of a complementary temporary signal 10 which in FIG. 2 is a traffic cone. Each transceiver 110 further comprises a microprocessor 117 which detects interruptions in a laser signal transmitted by the laser transmitter 111 of a first transceiver 110 and received by the laser receiver 112 of a second transceiver 110 and sends a signal to said control unit 130 using a wireless technology (Wi-Fi, Bluetooth, LoRa and/or the like).

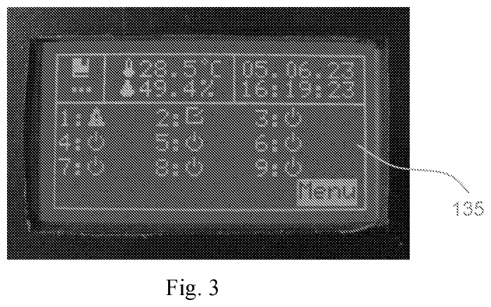

With reference to FIG. 3, it shows a view of the display 135 mounted on the control unit which detects the status of two active barriers and the environmental parameters.

Each transceiver 110 further comprises switches 118 able to activate and deactivate the laser signal between two transceivers 110 and an acoustic signal 119 able to send an acoustic signal when said microprocessor 117 detects an interruption of a laser signal between two transceivers 110 and to be turned on and turned off by means of said switches 118. Furthermore, said transceiver 110 comprises a plurality of indicator lights 120 able to send an optical signal when said microprocessor 117 detects an interruption of a laser signal between two transceivers 110, when two near transceivers 110 are misaligned, when two near transceivers 110 are aligned, when said transceiver 110 is on and running. Specifically, said light indicators 120 flash in the event of misalignment between said laser transmitters 111 and said laser receivers 112 and remain on in the event of alignment between said laser transmitters 111 and said laser receivers 112.

Said control unit 130 is able to acquire the signals from the microprocessors 117 of said transceivers 110 and to activate said acoustic signaling devices 140 and/or said optical signalers 150 when an interruption of a laser signal between two transceivers 110 is detected by a microprocessor 117. Said optical signalers 150 have a wireless communication unit 151 which receives data from said control unit 130 to send or not a light signal.

Said acoustic signaler 119, said indicator lights 120, said acoustic signaling devices 140, said optical signalers 150 able to signal to workers 2 when a person and/or a means and/or a vehicle passes between two transceivers 110 interrupting the laser signal, and signaling to vehicles in transit near said construction site 1, the presence of one or more workers 2 outside a perimeter outlined by said transceivers 110.

In some embodiments, said control unit 130 is equipped with a display 135 useful for displaying the date, time, temperature, relative humidity of the air and the activity status of the transceivers 110 and a system for recording said information on a removable micro-SD card. The system 100 is defined modular in that it allows the addition of any number of transceivers 110 to a first group of transceivers 110 already in operation at a construction site 1.

In some embodiments of the present invention, said interlocking anchor 116 comprises threaded holes with knobs that can be screwed to allow its fixing on complementary temporary signals 10 of various shapes such as roadway cones and signal posts. Said knobs which can be screwed are threaded bars with an ergonomic handle (preferably made of plastic, and preferably of a round shape with a diameter preferably comprised between 5 cm and 15 cm) which, inserted into the threaded holes, can be screwed until they contact the body of the complementary temporary signal 10, constraining the transceiver 110 thereto.

This same system of screwable knobs, in some embodiments of the invention, is used to create an adjustable anchor 131 comprised in said control unit and to position and anchor it to a complementary temporary signal 10.

In some embodiments of the present invention, said acoustic signaling device 140 is included inside said control unit 130.

In other embodiments of the present invention, said acoustic signaling devices 140 are ear devices (inserted inside the ears and/or noise-canceling headphones of the workers 2) provided to each worker 2 which emit an acoustic signal when they receive an input from said control unit 130 with communication based on Wi-Fi, Bluetooth and/or other wireless technology. Said acoustic signal can be a phrase recorded in various languages or can be a simple recognizable acoustic signal.

In some embodiments of the present invention, the system 100 comprises a support 160 for said transceiver 110 able to have a ballasted base 161. The dimensions and weight of the ballasted base are such as to generate a stabilizing moment greater than the overturning moment generated by the action of the wind on the transceiver 110 placed at the top of the support. Said ballasted base 161 is able to have a contact surface with the ground which is preferably circular and preferably with a radius comprised between 10 cm and 50 cm. The weight of said ballasted base 161 preferably being comprised between 2 kg and 15 kg. Said support 160 further comprises a central body 162 with adjustable height comprising extendable and/or retractable telescopic elements 163 and a case 164 able to contain said transceiver 110 and to absorb shocks. The case 164 is able to absorb shocks, being made with a soft internal material such as rubber, mineral wool and/or with an internal material in which a plurality of air bubbles are trapped such as plastic materials consisting of multiple thin plastic layers between which air bubbles of various sizes are trapped.

Finally, it is clear that modifications, additions or variations that are obvious to a person skilled in the art can be made to the invention described so far, without thereby departing from the scope of protection provided by the attached claims.

1. System (100) of laser barriers for a construction site (1) with workers (2) delimited by complementary temporary signals (10), which uses acoustic signaling devices (140) and optical signalers (150) characterized in that it comprises:
two or more transceivers (110) able to exchange a laser signal through a laser transmitter (111) and a laser receiver (112); each transceiver (110) comprising at least a laser transmitter (111) and at least a laser receiver (112); said laser transmitter (111) and laser receiver (112) mounted through articulated anchors (113) to a base (114) which provides support; said articulated anchors (113) allowing the orientation in the three dimensions of space of said laser transmitter (111) and laser receiver (112); said laser transmitter (111) and laser receiver (112) being energetically powered by a rechargeable battery power supply (115) included in said base (114); said base (114) having an interlocking anchor (116) to be able to interlock on top of a complementary temporary signal (10); each transceiver (110) further comprising a microprocessor (117) which detects interruptions in a laser signal transmitted by the laser transmitter (111) of a first transceiver (110) and received by the laser receiver (112) of a second transceiver (110) and sends a signal to a control unit (130); each transceiver (110) further comprising switches (118) adapted to activate and deactivate the laser signal between two transceivers (110); each transceiver (110) further comprising an acoustic signaler (119) able to send an acoustic signal when said microprocessor (117) detects an interruption of a laser signal between two transceivers (110) and to be turned on and off by means of said switches (118); each transceiver (110) further comprising a plurality of indicator lights (120) able to send an optical signal when said microprocessor (117) detects an interruption of a laser signal between two transceivers (110), when two neighboring transceivers (110) are misaligned, when two near transceivers (110) are aligned, when said transceiver (110) is on and running;
a control unit (130) able to acquire the signals of the microprocessors (117) of said transceivers (110) and to activate said acoustic signaling devices (140) and/or said optical signalers (150) when an interruption of a laser signal between two transceivers (110) is detected by a microprocessor (117); said optical signalers (150) able to have a wireless communication unit (151) which receives data from said control unit (130) to send or not a light signal;
said acoustic signaler (119), said indicator lights (120), said acoustic signaling devices (140), said optical signalers (150) able to signal to workers (2) when a person and/or a vehicle passes between two transceivers (110) interrupting the laser signal, and signaling to vehicles in transit near said construction site (1), the presence of one or more workers (2) outside a perimeter outlined by said transceivers (110).

2. System (100), according to the preceding claim 1, characterized in that it is modular allowing the addition of any number of transceivers (110) to a first group of transceivers (110) already in operation at a construction site (1).

3. System (100), according to the preceding claim 1, characterized in that said interlocking anchor (116) comprises threaded holes with knobs that can be screwed to allow its fixing on complementary temporary signals (10) of various shapes such as cones roadways and signal posts.

4. System (100), according to claim 1, characterized in that said acoustic signaling device (140) is included inside said control unit (130).

5. System (100), according to claim 1, characterized in that said acoustic signaling devices (140) are earphones provided to each worker (2) which emit an acoustic signal when they receive an input from said control unit (130) with communication based on Wi-Fi, Bluetooth and/or other wireless technology.

6. System (100), according to claim 1, characterized in that said control unit (130) comprises an adjustable anchor (131) to be positioned and anchored to a stable support.

7. System (100), according to claim 1, characterized in that said control unit (130) is equipped with a display (135) capable of displaying the date, time, temperature, relative humidity of the air and the activity status of the transceivers (110) and a system for recording said information on a removable micro-SD card.

8. System (100), according to claim 1, characterized in that it comprises a support (160) for said transceiver (110) able to have a weighted base (161), a central body (162) with adjustable height comprising of the telescopic elements (163), a case (164) able to contain said transceiver (110) and to absorb shocks.

9. System (100), according to claim 1, characterized in that said light indicators (120) flash in the event of misalignment between said laser transmitters (111) and said laser receivers (112) and remain on in the event of alignment between said laser transmitters (111) and said laser receivers (112).
